(19) United States
(12) Patent Application Publication
(10) Pub. No.: US 2018/0264842 A1
(43) Pub. Date: Sep. 20, 2018

(54) THERMAL PRINTER AND METHOD OF CONTROLLING THERMAL PRINTER

(71) Applicant: MITSUBISHI ELECTRIC CORPORATION, Tokyo (JP)

(72) Inventor: Naoyuki ABE, Tokyo (JP)

(73) Assignee: MITSUBISHI ELECTRIC CORPORATION, Tokyo (JP)

(21) Appl. No.: 15/542,613

(22) PCT Filed: Oct. 26, 2016
(86) PCT No.: PCT/JP2016/081719

§ 371 Date: Jul. 10, 2017

(51) Int. Cl. B41J 2/325; B41J 2/335

(52) U.S. Cl. CPC B41J 2/325; B41J 2202/30; B41J 2/33505

(57) ABSTRACT

It is an object to improve image quality of panoramic printing performed by a thermal printer. The thermal printer includes a joint position calculator and a controller. The joint position calculator specifies, in accordance with a less likelihood index of human visual recognition, a joint position between a plurality of images in panoramic printing including dividing a panoramic image longer than a print size of an ink ribbon into a plurality of images of a size equal to or less than the print size and printing in a plurality of times to join the plurality of images. The controller controls a print medium, the ink ribbon, and a thermal head to cause the plurality of images divided at the joint position to be joined by being heat transferred to a plurality of continuous areas of the print medium by a plurality of unit print areas of the ink ribbon, respectively.

### TECHNICAL FIELD

The present invention relates to a thermal printer and a method of controlling the thermal printer, particularly to a thermal printer to perform panoramic printing and a method of controlling the thermal printer.

### BACKGROUND ART

A thermal printer, to print by heat transferring an ink of an ink ribbon to a print medium such as rolled paper with use of a thermal head, has no restriction on length in a conveying direction (also called a vertical scanning direction) of the rolled paper as the print medium. The ink ribbon is, however, provided with inks in yellow (Y), magenta (M), and cyan (C), and of a protective layer (OP) of a prescribed size. The size of these inks limits a print size. The ink ribbon thus needs to be replaced in accordance with a desired print size.

Printing a long image in the vertical scanning direction such as a panoramic image requires an ink ribbon compatible with such a long print size. Such ink ribbons are not commonly distributed and are thus expensive.

In view of this, panoramic printing can be adopted as means for printing an image longer than the print size of a predetermined ink ribbon such as a panoramic image. Panoramic printing includes dividing a panoramic image for printing with combination of ink ribbons in a prescribed print size A panoramic image can be printed with the ink ribbon in the prescribed print size by dividing the panoramic image into a plurality of images of a size equal to or less than the print size of the ink ribbon. The plurality of divided images is printed in a plurality of times to be joined to a single print. However, simply overlapped printing to obtain such a joined print deteriorates image quality at a joint.

In view of this, the technique described in Patent Document 1 and the like improves image quality by reducing difference in density at a joint. The technique described in Patent Document 2 improves image quality by differentiating image correction between a portion printed before a joint and a portion printed after the joint to achieve constant density at the joint.

### PRIOR ART DOCUMENTS

### Patent Documents

Patent Document 1: Japanese Patent Application Laid-Open No. 2004-82610

Patent Document 2: International Publication No. WO 2011/125134 A

### SUMMARY OF INVENTION

### Problems to be Solved by the Invention

According to the conventional techniques described in Patent Documents 1 and 2, a panoramic image is divided into a plurality of images having a prescribed size as in the case of dividing a panoramic image of the 2L size into two images of the L size. As a thermal printer equipped with an ink ribbon of the L size to print an image of the L size, a print size is limited by the size of an ink ribbon.

The conventional techniques include dividing a panoramic image into images of the prescribed print size of the ink ribbon, so that a joint of panoramic printing can be provided in a portion likely to be recognized by human eyes.

The present invention has been achieved to solve this problem, and an object of the present invention is to provide a thermal printer and a method of controlling the thermal printer to provide a joint of panoramic printing at a position less likely to be recognized by human eyes to improve image quality of the panoramic printing.

### Means for Solving the Problems

The present invention provides a thermal printer to print by heat transferring, to a print medium with use of a thermal head, inks of an ink ribbon having a plurality of unit print areas provided with the inks by a prescribed print size unit. The thermal printer includes a joint position calculator and a controller. The joint position calculator specifies, in accordance with a less likelihood index of human visual recognition, a joint position between a plurality of images in panoramic printing including dividing a panoramic image longer than the print size of the ink ribbon into a plurality of images of a size equal to or less than the print size and printing in a plurality of times to join the plurality of images. The controller controls the print medium, the ink ribbon, and the thermal head to cause the plurality of images divided at the joint position specified by the joint position calculator to be joined by being heat transferred to a plurality of continuous areas of the print medium by the plurality of unit print areas of the ink ribbon, respectively.

The present invention also provides a method of controlling a thermal printer to print by the heat transferring, to a print medium with use of a thermal head, inks of an ink ribbon having a plurality of unit print areas provided with the inks by a prescribed print size unit. The method of controlling the thermal primer includes a first step of specifying, in accordance with a less likelihood index of human visual recognition, a joint position between a plurality of images in panoramic printing including dividing a panoramic image longer than the print size of the ink ribbon into a plurality of images of a size equal to or less than the print size and printing in a plurality of times to join the plurality of images, and a second step of controlling the print medium, the ink ribbon, and the thermal head to cause the plurality of images divided at the joint position specified in the first step to be joined by being heat transferred to a plurality of continuous areas of the print medium by the plurality of unit print areas of the ink ribbon, respectively.

### Effect of the Invention

The present invention includes specifying the joint position between the plurality of images in panoramic printing in accordance with the less likelihood index of human visual recognition, to cause human eyes to be less likely to recognize the joint of the panoramic printing. The present invention thus improves image quality of panoramic printing.

The object, features, aspects, and advantages of the present invention will be more clarified in the following detailed description and the accompanying drawings.

### BRIEF DESCRIPTION OF DRAWINGS

FIG. 1 is a view of a panoramic print outputted from a thermal printer according to an embodiment 1.

FIG. 2 is a view of an ink ribbon included in the thermal printer according to the embodiment 1.

FIG. 3 is a block diagram depicting a configuration of the thermal printer according to the embodiment 1.

FIG. 4 is a flowchart of a process of dividing a panoramic image executed by the thermal printer according to the embodiment 1.

FIG. 5 is a block diagram depicting a configuration of a thermal printer according to an embodiment 2.

FIG. 6 is a flowchart of a process of dividing a panoramic image executed by the thermal printer according to the embodiment 2.

FIG. 7 is a block diagram depicting a configuration of a thermal printer according to an embodiment 3.

FIG. 8 is a flowchart of a process of dividing a panoramic image executed by the thermal printer according to the embodiment 3.

### DESCRIPTION OF EMBODIMENTS

Embodiments of the present invention will now be described with reference to the accompanying drawings in order for more detailed description of the present invent on.

### Embodiment 1

Described below is a method of dividing a panoramic image and performing panoramic printing in an exemplary case of dividing a panoramic image received by a thermal printer into three images and performing panoramic printing.

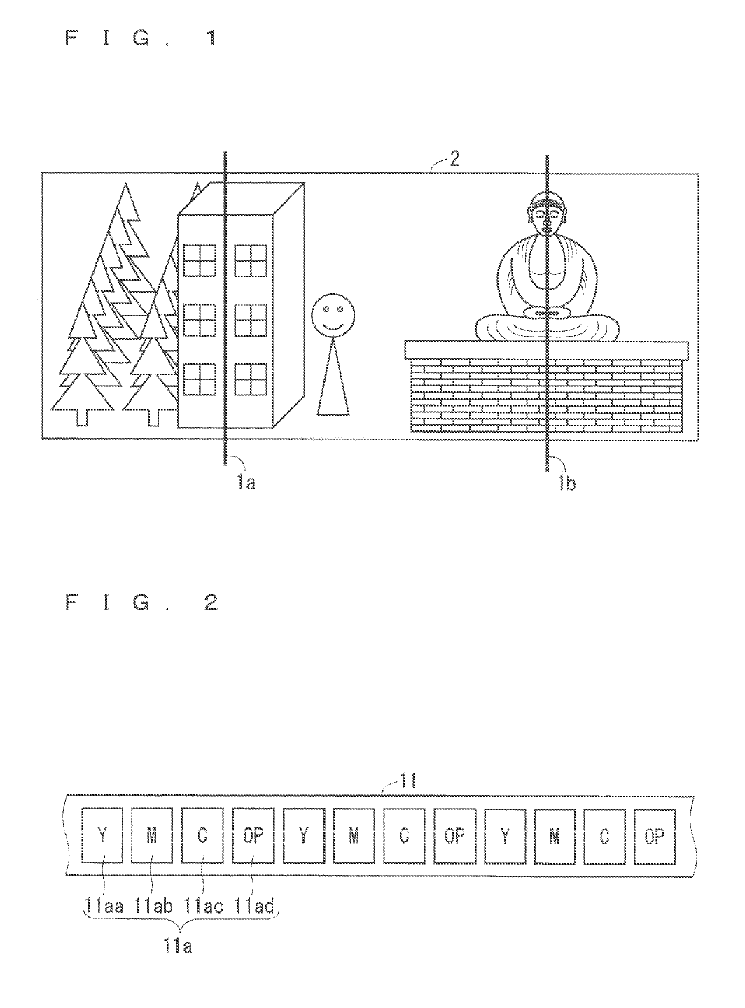

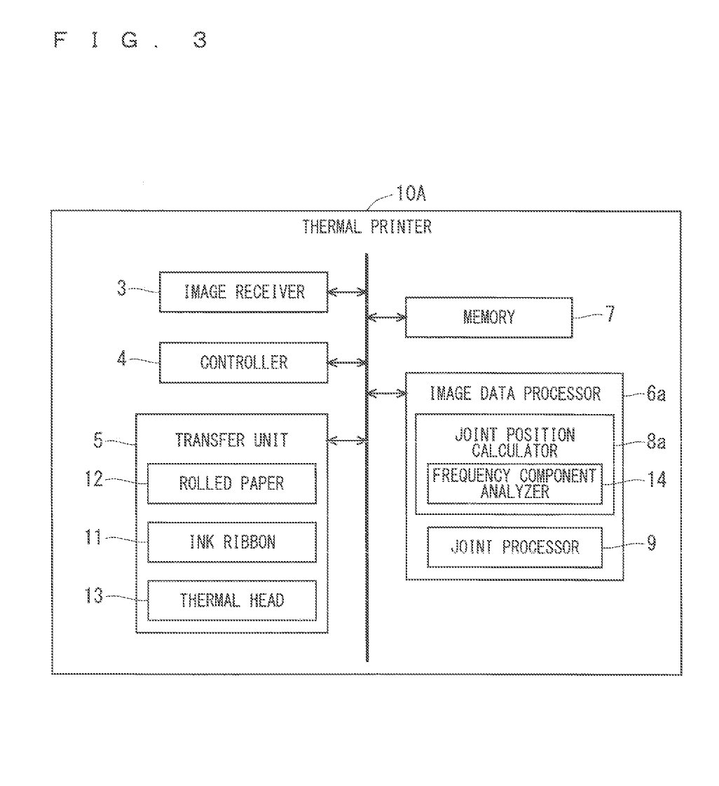

FIG. 1 depicts an exemplary panoramic print 2 of a panoramic image outputted from a thermal printer 10A according to the embodiment 1 of the present invention, FIG. 2 is a view of an exemplary configuration of an ink ribbon 11 included in the thermal printer 10A according to the embodiment 1.

FIG. 2 exemplifies the ink ribbon 11 having a plurality of unit print areas 11a. The unit print areas 11a are each provided with four inks 11aa to 11ad in yellow (Y), magenta (M), and cyan (C), and of a protective layer (OP) of a prescribed size, aligned in the mentioned order in a vertical scanning direction. Ordinary printing is performed by heat transferring, to a print medium, the four inks 11aa to 11ad in the single unit print area 11a to obtain a single print.

Panoramic printing includes dividing a panoramic image longer in the vertical scanning direction than a print size of the ink ribbon 11, i.e. each size of the inks 11aa to 11ad, into a plurality of images of a size equal to or less than the print size. FIG. 1 exemplifies dividing the panoramic image into three images and printing the three images joined at two joint positions 1a and 1b to obtain the single panoramic print 2.

<Configuration of Thermal Printer>

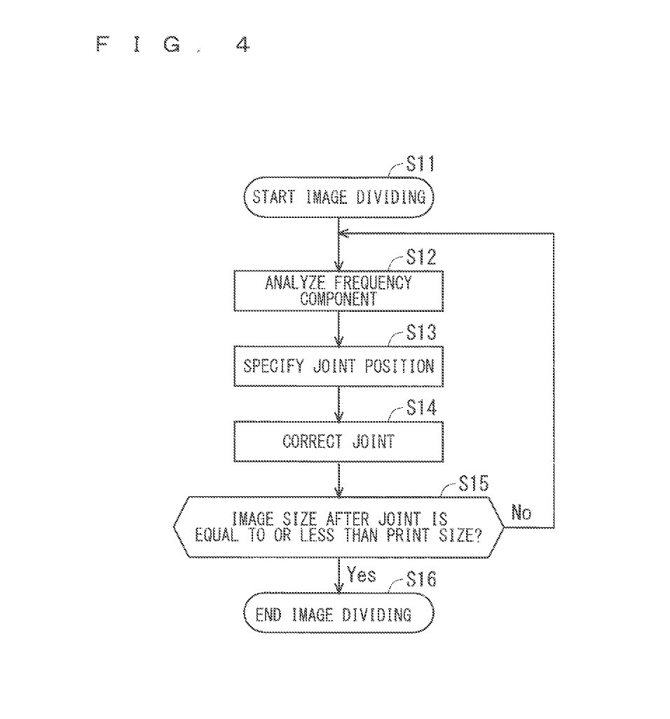

FIG. 3 is a block diagram of an exemplary configuration of the thermal printer 10A according to the embodiment 1 of the present invention. As depicted in FIG. 3, the thermal printer 10A includes an image receiver 3, a memory 7, an image data processor 6a, a controller 4, and a transfer unit 5.

The image receiver 3 receives data of an image to be printed by the thermal printer 10A. The image receiver 3 receives the image data via a universal serial bus (USB) memory, a memory card, a wired/wireless network, or the like.

Examples of the memory 7 include a nonvolatile or volatile semiconductor memory such as a RAM, a ROM, a flash memory, an EPROM, or an EEPROM, as well as a magnetic disk, a flexible disk, an optical disk, a compact disk, a mini disk, and a DVD.

The memory 7 stores a program for control of respective constituent elements of the thermal printer 10A such as a program for calculation of a joint position in image data to be described later, an image data processing program such as a joint processing program for improvement in image quality at the joint, the image data received by the image receiver 3, and the like.

The image data processor 6a applies various image processing to the image data stored in the memory 7. The image data processor 6a includes a joint position calculator 8a having a frequency component analyzer 14, and a joint processor 9. The joint position calculator 8a and the joint processor 9 each have a function achieved by the image data processor 6a.

The frequency component analyzer 14 in the joint position calculator 8a analyzes a frequency component of the image data received by the image receiver 3. The joint position calculator 8a specifies a joint position of panoramic printing using the image data in accordance with an analytical result of the frequency component by the frequency component analyzer 14. The joint processor 9 performs correction to improve image quality at the joint position specified by the joint position calculator 8a. Behavior of the image data processor 6a will be described in detail later.

The controller 4 controls the respective constituent elements of the thermal printer 10A. The controller 4 controls a motor and a sensor (not depicted), for example, to shift the ink ribbon 11 and rolled paper 12 as a print medium, and controls a thermal head 13 to control printing behavior of the transfer unit 5.

The transfer unit 5 includes the ink ribbon 11, the rolled paper 12 as a print medium, and the thermal head 13. The transfer unit 5 is controlled by the controller 4 to print using image data image processed by the image data processor 6a by heat transferring the inks 11aa to 11ad of the ink ribbon 11 to the rolled paper 12 with use of the thermal head 13.

The image data processor 6a and the controller 4 can be configured by dedicated hardware or by a central processing unit (CPU, also called a central processing device, a processing device, an operation device, a microprocessor, a microcomputer, processor, or a DSP) to execute the program stored in the memory 7.

Examples of the image data processor 6a and the controller 4 configured by dedicated hardware include a single circuit, a composite circuit, a programmed processor, a parallel programmed processor, an ASIC, an FPGA, and combinations thereof.

In a case where the image data processor 6a is configured by a CPU, the functions of the joint position calculator 8a and the joint processor 9 are achieved by software, firmware, or a combination of software and firmware. Such software or firmware is described as a program stored in the memory 7. The image data processor 6a reads and executes the program stored in the memory 7 to achieve the functions of the joint position calculator 8a and the joint processor 9. This program is also configured to cause a computer to execute a procedure or a method performed by each of the joint position calculator 8a and the joint processor 9.

The controller 4 configured by a CPU reads and executes the program stored in the memory 7 to achieve the functions of controlling the respective constituent elements in the thermal printer 10A.

Part of the functions of the image data processor 6a and the controller 4 can be achieved by dedicated hardware and another part thereof can be achieved by software or firmware.

<Behavior of Thermal Printer>

After the memory 7 stores image data of a panoramic image received by the image receiver 3, the thermal printer 10A divides the panoramic image to perform panoramic printing with use of the image data.

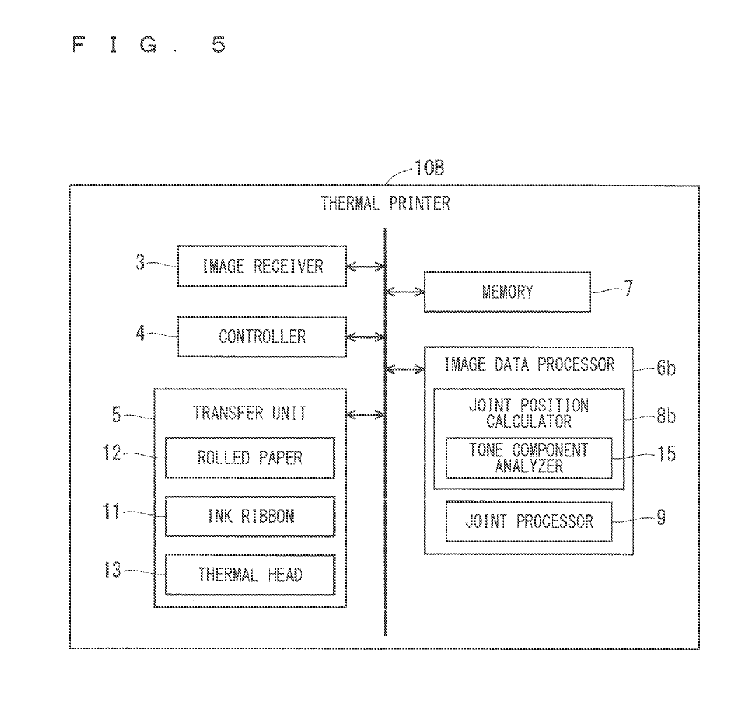

FIG. 4 is a flowchart of a process of dividing the panoramic image executed by the thermal printer 10A according to the embodiment 1 of the present invention. As depicted in FIG. 4, dividing the panoramic image starts in step S11.

Subsequently in step S12, the frequency component analyzer 14 analyzes a frequency component (also called a “spatial frequency”) in a predetermined area including a joint position to be specified in the panoramic image. In step S12 executed firstly, the predetermined area extends the length of the print size in the vertical scanning direction, from a start point of the panoramic image to be initially printed in the vertical scanning direction. In step S12 executed secondly and thereafter, the predetermined area extends the length of the print size in the vertical scanning direction, from the joint position specified in step S13 in the most recent process.

The frequency component analyzer 14 analyzes the image frequency component in accordance with two-dimensional Fourier transform, discrete cosine transform, or the like. The technique for analyzing the image frequency component is not limited to these exemplary techniques.

Then in step S13, the joint position calculator 8a specifies a joint position of panoramic printing in accordance with the analytical result of the frequency component in step S12. The joint position calculator 8a according to the present embodiment specifies the joint position of panoramic printing in accordance with a level of the frequency component analyzed in step S12 as a less likelihood index of human visual recognition.

A portion with many low frequency components in an image has small image change. A joint provided at such a position upon panoramic printing is likely to be recognized by human eyes. In contrast, a portion with many high frequency components in an image has large image change. A joint provided at such a position upon panoramic printing is less likely to be recognized by human eyes.

The joint position calculator 8a specifies, as joint position of panoramic printing, a portion with the highest spatial frequency in the vertical scanning direction in the predetermined area including a joint position to be specified, for example.

The joint position calculator 8a can alternatively specify a joint position allowing divided images to have the longest sizes in a portion with a spatial frequency equal to or more than a predetermined value in the vertical scanning direction in the predetermined area including a joint position to be specified. This reduces the number of the divided images to achieve reduction in the number times of heat transferring.

The predetermined area including a joint position to be specified by the joint position calculator 8a can alternatively be obtained by removing, from a first area extending the length of the print size in the vertical scanning direction from the start point of the panoramic image or the joint position specified in the most recent process, a second area extending predetermined length from a start point of the first area. This also achieves reduction in the number of divided images from the panoramic image.

Then in step S14, the joint processor 9 corrects the joint to improve image quality at the joint in the image including the joint position specified in step S13 in accordance with the technique described in Patent Document 1 or the like. The technique for correcting the joint is not limited to that according to Patent Document 1.

Next in step S15, the joint position calculator 8a determines whether or not the length in the vertical scanning direction of the image after the joint position specified in step S13 in the panoramic image is equal to or less than the print size of the ink ribbon 11.

When the length of the image after the joint is determined as being not equal to or less than the print size in step S15, the series of processes from steps S12 to S15 are executed again.

When the length of the image after the joint is determined as being equal to or less than the print size in step S15, image dividing ends in step S16.

The transfer unit 5 is then controlled by the controller 4 and performs panoramic printing in accordance with the joint position specified in step S13. Specifically, the controller 4 controls the transfer unit 5 to cause the plurality of images divided at the joint position specified in step S13 to be joined by being heat transferred to a plurality of continuous areas of the rolled paper 12 by the plurality of unit print areas 11a of the ink ribbon 11, respectively. This achieves the panoramic print 2 as depicted in FIG. 1.

The thermal printer 10A according to the present embodiment does not divide a panoramic image into images of a prescribed size as in the conventional techniques, but the joint position calculator 8a specifies a joint position in accordance with the less likelihood index of human visual recognition. The joint is provided at a position less likely to be recognized by human eyes. This configuration thus improves image quality of panoramic printing.

The joint position calculator 8a further specifies the joint position in accordance with the image frequency component analyzed by the frequency component analyzer 14. The joint of panoramic printing is thus provided at a position with large change in image pattern, i.e. a position less likely to be recognized by human eyes.

### Embodiment 2

The embodiment 2 of the present invention includes specifying a joint position of panoramic printing in accordance with a tone component, instead of a frequency component of a panoramic image in the embodiment 1.

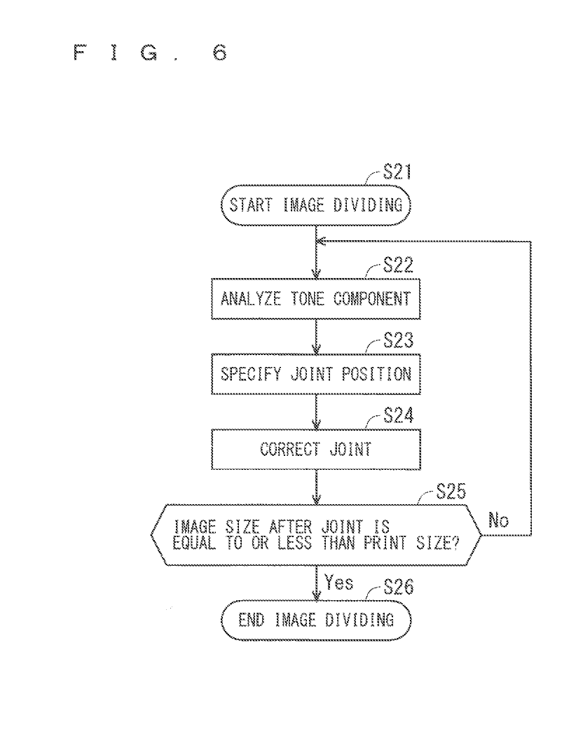

FIG. 5 is a block diagram of an exemplary configuration of a thermal printer 10B according to the embodiment 2 of the present invention. As depicted in FIG. 5, the thermal printer 10B includes an image data processor 6b in place of the image data processor 6a included in the thermal printer 10A depicted in FIG. 3. Constituent elements identical to those described in the embodiment 1 will be denoted by identical reference signs and will not be described repeatedly in the embodiment 2.

The image data processor 6b applies various image processing to image data stored in the memory 7. The image data processor 6b includes a joint position calculator 8b having a tone component analyzer 15, and the joint processor 9. The joint position calculator 8b and the joint processor 9 each have a function achieved by the image data processor 6b.

Similarly to the image data processor 6a, the image data processor 6b can be configured by dedicated hardware or a CPU to execute a program stored in the memory 7.

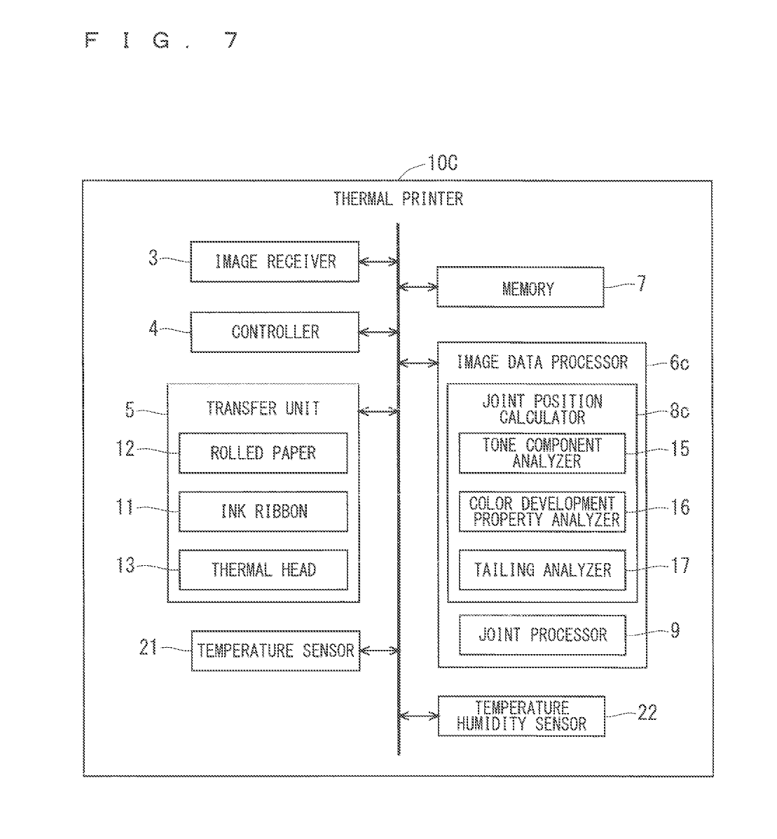

FIG. 6 is a flowchart of a process of dividing a panoramic image executed by the thermal printer 10B according to the embodiment 2 of the present invention. Steps S21 and S24 to S26 in FIG. 6 are similar to steps S11 and S14 to S16 in FIG. 4 and will not be described in detail repeatedly.

As depicted in FIG. 6, processing in step S22 is executed after image dividing starts in step S21. In step S22, the tone component analyzer 15 in the joint position calculator 8b analyzes an image tone component in a predetermined area including a joint position to be specified in the panoramic image. The predetermined area is similar to the predetermined area including a joint position to be specified by the joint position calculator 8a according to the embodiment 1, and will not be described in detail repeatedly.

Then in step S23, the joint position calculator 8b specifies a joint position of panoramic printing in accordance with an analytical result of the tone component in step S22. The joint position calculator 8b according to the present embodiment specifies the joint position of panoramic printing in accordance with an amount of change of the tone component analyzed in step S22 as a less likelihood index of human visual recognition.

A joint provided in a uniform portion with small tone change in an image is typically likely to be recognized by human eyes. In contrast, a joint provided in a portion with large tone change in an image upon panoramic printing is less likely to be recognized by human eyes.

The joint position calculator 8b specifies, as a joint position of panoramic printing, a portion with the largest tone change in the vertical scanning direction in the predetermined area including a joint position to be specified, for example.

The joint position calculator 8b can alternatively specify, as a joint position, a position allowing divided images to have the longest sizes in a portion with tone change in the vertical scanning direction equal to or lore than a predetermined value in the predetermined area including a joint position to be specified. This reduces the number of the divided images to achieve reduction in the number times of heat transferring.

In the thermal printer 10B according to the present embodiment, the joint position calculator 8b specifies the joint position in accordance with the image tone component analyzed by the tone component analyzer 15. The joint of panoramic printing is thus provided at a position with an ununiform image, i.e. a position less likely to be recognized by human eyes.

### Embodiment 3

The embodiment 3 of the present invention includes specifying a joint position of panoramic printing in accordance with a tailing analytical result, instead of an image tone component in the embodiment 2.

The expression “tailing” indicates a phenomenon that a brushed portion in a dark color extends in an area in a light color when a thermal printer prints an image including a quite light area immediately after a quite dark area. A joint of panoramic printing provided in such a tailed area will be likely to be recognized by human eyes.

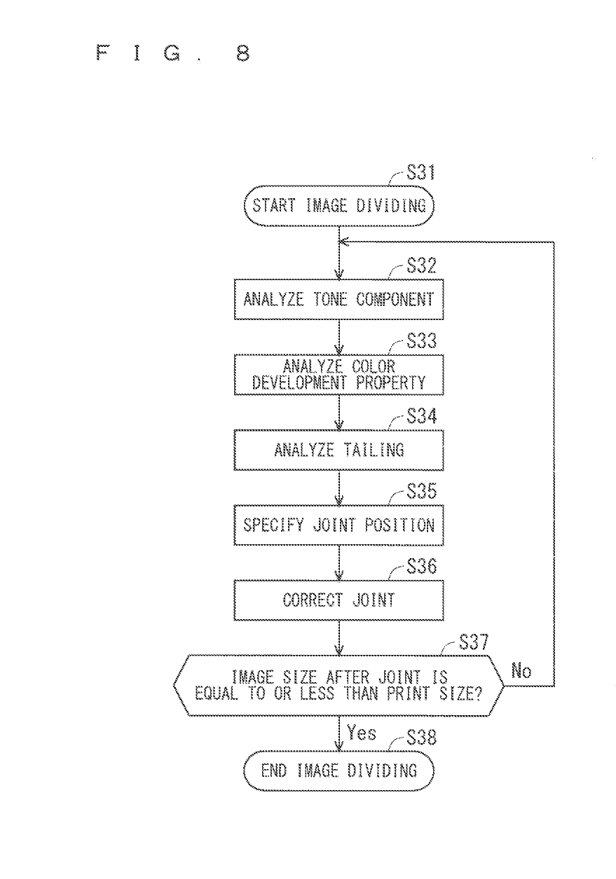

FIG. 7 is a block diagram of an exemplary configuration of a thermal printer 10C according to the embodiment 3 of the present invention. As depicted in FIG. 7, the thermal printer 10C according to the embodiment 3 further includes a temperature sensor and a temperature humidity sensor 22 as compared with the thermal printer 10B depicted in FIG. 5. Moreover, the image data processor 6b is replaced with an image data processor 6c. Constituent elements identical to those described in the embodiments 1 and 2 will be denoted by identical reference signs and will not be described repeatedly in the embodiment 3.

The temperature sensor 21 measures temperature of the thermal head 13. The temperature humidity sensor 22 measures temperature and humidity in the thermal printer 10C.

The image data processor 6c applies various image processing to image data stored in the memory 7. The image data processor 6c includes a joint position calculator 8c and the joint processor 9. The joint position calculator 8c has the tone component analyzer 15, a color development property analyzer 16, and a tailing analyzer 17. The joint position calculator 8b and the joint processor 9 each have a function achieved by the image data processor 6c.

Similarly to the image data processor 6a and 6b, the image data processor 6c can be configured by dedicated hardware or a CPU to execute a program stored in the memory 7.

FIG. 8 is a flowchart of a process of dividing a panoramic image executed by the thermal printer 10C according to the embodiment 3 of the present invention. Steps S31, S32, and S36 to S38 in FIG. 8 are similar to steps S21, S22, and S24 to 26 in FIG. 6 and will not be described in detail repeatedly.

As depicted in FIG. 8, processing in step S32 is executed after image dividing starts in step S31. In step S32, the tone component analyzer 15 in the joint position calculator 8c analyzes an image tone component in a predetermined area including a joint position to be specified in the panoramic image. The predetermined area is similar to the predetermined area including a joint position to be specified by the joint position calculator 8a according to the embodiment 1, and will not be described in detail repeatedly.

Subsequently in step S33, the color development property analyzer 16 in the joint position calculator 8c analyzes a color development property of the inks 11aa to 11ad heat transferred to the roiled paper 12 in accordance with measurement results of temperature and humidity in the thermal printer 10C detected by the temperature humidity sensor 22 and temperature of the thermal head 13 detected by the temperature sensor 21.

Then in step S34, the tailing analyzer 17 in the joint position calculator 8c analyzes image tailing in accordance with the analytical result of the tone component in step S32 and the analytical result of the color development property in step S33. The tailing analyzer 17 assumes that tailing is likely to occur at a position where an image tone component changes by a predetermined amount from a high tone to a low tone in the vertical scanning direction, for example.

In step S35, the joint position calculator 8c specifies a joint position of panoramic printing in accordance with the tailing analytical result in step S34. The joint position calculator 8c according to the present embodiment specifies the joint position of panoramic printing in accordance with a tailing amount analyzed in step S34 as a less likelihood index of human visual recognition.

A joint provided in a portion with more tailing is likely to be recognized by human eyes. In contrast, a joint provided in a portion with less tailing upon panoramic printing is less likely to be recognized by human eyes.

The joint position calculator 8c specifies, as a joint position of panoramic printing, a portion with the least tailing in the predetermined area including a joint position to be specified, for example.

The joint position calculator 8c can alternatively specify, as a joint position, a position allowing divided images to have the longest sizes in a portion with tailing less than a predetermined value in the predetermined area including a joint position to be specified. This reduces the number of the divided images to achieve reduction in the number times of heat transferring.

In the thermal printer 10C according to the present embodiment, the joint position calculator 8b specifies the joint position in accordance with the image tailing analyzed by the tailing analyzer 17. The joint of panoramic printing is thus provided at a position with less tailing, i.e. where a joint is less likely to be recognized by human eyes.

Any of these embodiments of the present invention can be combined freely or be modified or removed appropriately within the scope of the present invention.

The present invention has been described in detail exemplarily in all aspects and should not be limited to the description. An infinite number of modification examples not exemplified herein should be regarded as assumable without being excluded from the scope of the present invention.

### REFERENCE SIGNS LIST

1a, 1b: joint position

2: panoramic print

3: image receiver

4: controller

5: transfer unit

6a to 6c: image data processor

7: memory

8a to 8c: joint position calculator

9: joint processor

10A to 10C: thermal printer

11: ink ribbon

11a: unit print area

11aa to 11ad: ink

12: rolled paper

13: thermal head

14: frequency component analyzer

15: tone component analyzer

16: color development property analyzer

17: tailing analyzer

21: temperature sensor

22: temperature humidity sensor

1. A thermal printer to print by heat transferring, to a print medium with use of a thermal head, inks of an ink ribbon having a plurality of unit print areas provided with said inks by a prescribed print size unit, the thermal printer comprising:
a joint position calculator to specify, in panoramic printing including dividing a panoramic image longer than said print size of said ink ribbon into a plurality of images of a size equal to or less than said print size and printing in a plurality of times to join said plurality of images, a joint position between said plurality of images in accordance with a less likelihood index of human visual recognition; and
a controller to control said print medium, said ink ribbon, and said thermal head to cause said plurality of images divided at said joint position specified by said joint position calculator to be joined by being heat transferred to a plurality of continuous areas of said print medium by said plurality of unit print areas of said ink ribbon, respectively.

2. The thermal printer according to claim 1, wherein
said joint position calculator specifies said joint position in accordance with a frequency component of said panoramic image.

3. The thermal printer according to claim 2, wherein
said joint position calculator specifies, as said joint position, a position where said frequency component is the highest in a length direction of said panoramic image in a predetermined area including said joint position to be specified in said panoramic image.

4. The thermal printer according to claim 1, wherein
said joint position calculator specifies said joint position in accordance with a tone component of said panoramic image.

5. The thermal printer according to claim 4, wherein said joint position calculator specifies, as said joint position, a position where change of said tone component is the largest in a length direction of said panoramic image in a predetermined area including said joint position to be specified in said panoramic image.

6. The thermal printer according to claim 1, further comprising:
a temperature sensor to measure temperature of said thermal head; and
a temperature humidity sensor to measure temperature and humidity in said thermal printer; wherein
said joint position calculator calculates a color development property of said inks heat transferred to said print medium in accordance with temperature of said thermal head measured by said temperature sensor, and temperature and humidity in said thermal printer measured by said temperature humidity sensor, and specifies said joint position in accordance with said color development property and the tone component of said panoramic image.

7. The thermal printer according to claim 6, wherein
said joint position calculator calculates tailing of said printed panoramic image in accordance with said color development property and said tone component, and specifies, as said joint position, a position where said tailing is the least in a length direction of said panoramic image in a predetermined area including said joint position to be specified in said panoramic image.

8. A method of controlling a thermal printer to print by heat transferring, to a print medium with use of a thermal head, inks of an ink ribbon having a plurality of unit print areas provided with said inks by a prescribed print size unit, the method comprising:
specifying, in panoramic printing including dividing a panoramic image longer than said print size of said ink ribbon into a plurality of images of a size equal to or less than said print size and printing in a plurality of times to join said plurality of images, a joint position between said plurality of images in accordance with a less likelihood index of human visual recognition; and
controlling said print medium, said ink ribbon, and said thermal head to cause said plurality of images divided at said joint position specified to be joined by being heat transferred to a plurality of continuous areas of said print medium by said plurality of unit print areas of said ink ribbon, respectively.
